(19) United States
(12) Patent Application Publication
(10) Pub. No.: US 2022/0227446 A1
(43) Pub. Date: Jul. 21, 2022

(54) MOTORIZED SCOOTER

(71) Applicant: Taur Technologies Limited, Horsham, West Sussex (GB)

(72) Inventors: Carson BROWN, Horsham, West Sussex (GB); Richard ADEY, Horsham, West Sussex (GB)

(21) Appl. No.: 17/608,630

(22) PCT Filed: May 1, 2020
(86) PCT No.: PCT/GB2020/051075

§ 371 Date: Nov. 3, 2021

(30) Foreign Application Priority Data
May 3, 2019 (GB) 1906280.1

(51) Int. Cl. B62K 3/00; B62K 15/00

(52) U.S. Cl. CPC B62K 3/002; B62M 6/45; B62K 15/006

(57) ABSTRACT

A motorized scooter, for which an operation of the motorized wheel can be controlled based on a pitch of the foot platform. A motor control unit is operable in at least one pitch control mode, in which the operation of the motorized wheel is based upon the pitch of the foot platform, and a drive mode, in which the user controls the operation of the motorized wheel via a user input interface, in the manner of a conventional motorized scooter.

### FIELD OF THE INVENTION

The present invention relates to the field of scooters, and in particular to motorized scooters.

### BACKGROUND OF THE INVENTION

Motorized scooters are effectively a “kick scooter” or “stand-up scooter” with a motorized wheel that provides propulsive power. To operate the motorized scooter, a user typically stands upright upon a foot platform and controls a speed via a user input interface (e.g. a throttle lever or twistgrip). A motorized scooter should be distinguished from “motor scooters” or simply “scooters”, which are a type of motorcycle comprising a seat. Thus, motorized scooters are usually seatless.

Typically, a motorized wheel for a motorized scooter comprises a petrol/gas motor or an electric motor, which is controlled in response to a user input to drive a wheel. Recent trends indicate that electric kick scooters, comprising an electric motor, are more popular than those comprising a petrol/gas motor, as they are more environmentally friendly, easier to control and less dangerous in use.

There has been an increasing interest in the use of motorized scooters within urban environments, e.g. cities or towns, to provide a cheap and simple way for quick transportation about urban environments.

However, an ongoing problem with motorized scooters is the difficulty in transportation when it cannot be ridden by the user, e.g. due to lack of space or other location restrictions. For example, it is common for train stations to ban the use of motorized scooters, and it would be difficult to ride a motorized scooter within a building. However, the weight of a motorized scooter makes it difficult or uncomfortable to transport or carry for long distances.

There is therefore a desire for a motorized scooter that is easy to transport when it is not being ridden by the user.

### SUMMARY OF THE INVENTION

The invention is defined by the claims.

According to examples in accordance with an aspect of the invention, there is provided a motorized scooter for transporting a user across a ground surface. The motorized scooter comprises: a foot platform adapted to support at least one foot of the user; a motorized wheel connected to a first end of the foot platform; a second wheel connected to a second, opposite end of the foot platform; a handle for supporting a hand of the user; a user input interface for receiving a first user input indicative of a desired speed of the motorized scooter; a balance sensor adapted to identify a pitch of the foot platform with respect to a horizontal plane; and a motor control unit adapted to control an operation of the motorized wheel and operable in at least: a drive mode, during which the motor control unit controls the operation of the motorized wheel responsive to the user input; and at least one pitch control mode, during which the motor control unit controls the operation of the motorized wheel based on the detected pitch of the foot platform.

The invention therefore provides a motorized scooter that can exploit self-balancing functionality to assist a user in transporting the motorized scooter when they are not riding it. The motorized scooter assists the user by controlling the motorized wheel based on the pitch of the foot platform, which allows the wheel to assist in maintaining or changing a pitch of the foot platform, for ease of maneuvering the scooter.

In the context of the present disclosure, a motorized scooter is effectively a motorized kick scooter (sometimes called a motorized push-scooter). The motorized wheel and the second wheel are offset from one another (i.e. they do not rotate about a same axis).

The motor control unit is adapted to drive a motorized wheel of the scooter based on a determined pitch of the foot platform (i.e. a fore-aft tilt). The term “pitch” is used to refer to a fore-aft tilt of the foot platform, i.e. about an axis perpendicular to a direction of travel of the scooter.

The pitch is used herein to refer to the amount that the foot platform has rotated about the motorized wheel, with respect to a position in which the foot platform lies when both the motorized wheel and the second wheel are in contact with a horizontal ground surface. In particular, the pitch is calibrated so that a “zero pitch”, i.e. a pitch of 0°, of the foot platform occurs when the motorized wheel and the second wheel contact a ground surface lying in a horizontal plane. Typically, although not essentially, this means that when the foot platform is at “zero pitch”, then it also lies in the horizontal plane.

The “pitch” of the foot platform is therefore the difference between the current angle of the foot platform, with respect to the horizontal plane, and the angle of the foot platform, with respect to the horizontal plane, when the foot platform is at a “zero pitch”.

It will therefore be apparent that, if the ground surface lies in the horizontal plane, the second wheel is placed at a predefined non-zero distance from the horizontal plane when the motor control unit places the foot platform at a corresponding predefined non-zero pitch with the motorized wheel in contact with the ground surface.

It will be appreciated that the user will not, or should not, be able to ride the scooter when the motor control unit is in a pitch control mode.

Different embodiments for a pitch control mode are envisaged.

In one example, at least one pitch control mode is a pitch placement mode, in which the motor control unit controls the motorized wheel to place the pitch of the foot platform at a predefined non-zero pitch. In preferred embodiments, the predefined non-zero pitch of each placement control mode is in the range of from 20° to 90° from the horizontal plane. In even more preferred embodiments, the predefined non-zero pitch of each pitch control mode is in the range of from 60° to 90° from the horizontal plane.

The at least one pitch control mode may comprise a pitch maintaining mode, in which the motor control unit maintains the pitch of the foot platform at a predefined non-zero pitch, or range of non-zero pitches, with respect to the horizontal plane.

The at least one pitch control mode may comprise a vertical balancing mode in which the motor control unit maintains the pitch of the foot platform at a first non-zero pitch with respect to the horizontal plane, wherein the first non-zero pitch is in the range of from 80° to 90° from the horizontal plane. The vertical balancing mode is an example of a pitch maintaining mode.

In other words, in a preferred embodiment the motor control unit is adapted to maintain the foot platform in the vertical plane (i.e. perpendicular to the horizontal plane). This minimizes a horizontal space occupied by the motorized scooter, making it more convenient for travelling in a limited space (e.g. on a bus or train). Maintaining the foot platform in the vertical plane also increases an ease of transporting the motorized scooter, as the scooter will respond to attempts changes in the pitch of the scooter (e.g. attempted pushes or pulls by the user).

Moreover, turning the scooter to change its direction, i.e. yawing, is simpler when balancing on a single wheel as the motorized wheel has only a small contact area with the ground surface.

In some embodiments, the handle is configured to be moveable with respect to the foot platform between at least a first position, in which the handle is more distant from the foot platform, and a second position, in which the handle is more proximate to the foot platform; and the motor control unit is configured to be operable in a pitch control mode only when the handle lies in the second position.

To improve safety of the motorized scooter, the motor control unit may be inoperable in the pitch control mode when the motorized scooter is configured for riding (i.e. when the handle is in the first position). This prevents the pitch control mode from activating and overriding the drive mode during normal operation of the motorized scooter, i.e. when the scooter is being used to transport the user.

The handle may be configured to be proximate to the second end of the foot platform when in the second position.

In some embodiments, wherein the handle comprises: a user gripping portion; a rotatable mechanism connected to the foot platform; and an elongate portion connecting the user gripping portion to the rotatable mechanism, so that the elongate portion and user gripping portion are able to together rotate with respect to the foot platform via the rotating mechanism.

Thus, the motorized scooter may be a foldable scooter. This enables the motorized scooter to be decreased in size for transportation.

The user interface may be further adapted to receive a second user input indicative of a user's desire to operate the motor control unit in a pitch control mode, wherein the motor control unit is adapted to enter a pitch control mode in response to the user interface receiving the second user input.

Thus, the motorized scooter may enter a pitch control mode in response to a user input. In some embodiments, the pitch control mode entered by the motorized scooter may be based upon the user input, e.g. the user pressing a particular button or providing a particular input (e.g. pattern of button presses or a setting of a dial/slider).

The motor control unit is optionally adapted to enter a pitch control mode in response to the balance sensor determining that the pitch of the motorized scooter, with respect to the horizontal surface, is greater than or equal to a second predefined non-zero pitch.

In some embodiments, the at least one pitch control mode comprises a drag balancing mode for use when the user desires to drag the motorized scooter. The motor control unit is adapted to, when operating in the drag balancing mode: in response to the pitch of the foot platform falling within a first range with respect to the horizontal plane, control the motorized wheel to apply a propulsive force; and in response to the pitch of the foot platform falling outside the first range, control the motorized wheel to not apply the propulsive force.

The motorized scooter is “dragged” if the motorized wheel is placed behind the part held by the user (when transporting the motorized scooter) with respect to a user's direction of travel. Accelerating the motorized wheel in this scenario causes the pitch of the foot platform to change. This is because the user will naturally resist forward movement of the scooter, causing the angle of the foot platform to be altered (namely, angling the foot platform further away from the user).

In some embodiments, the motorized scooter may be able to detect when the user is dragging or intends to drag the motorized scooter, e.g. via a handle-based force sensors or accelerometer information. The control unit may enter the drag balancing mode in response to the motorized scooter detecting that the user is or intends to drag the motorized scooter.

In some embodiments, the motor control unit may enter the drag balancing mode in response to the pitch of the foot platform falling within a certain range, e.g. within the first range. Other methods of entering the drag balancing mode will be apparent to the skilled person, e.g. based on a user input, in response to the pitch falling within a predefined range for at least a predefined period of time, in response to the pitch falling within a certain range and a predefined user input being provided and so on.

The first range may comprises a first upper limit and an optional first lower limit. The motor control unit may be adapted to, when operating in the drag balancing mode, in response to the pitch of the foot platform being at or above the first upper limit, or (optionally) at or below the first lower limit, control the motorized wheel to not apply the propulsive force.

Embodiments using the optional first lower limit improve a safety of the motorized scooter. In particular, the first lower limit may be an angle that may occur if the motorized scooter is simply picked up (e.g. by the foot platform). By setting a lower limit, this would prevent the motorized wheel from operating when the motorized scooter is picked up when operating in the drag balancing mode.

In some embodiments, the step of applying a propulsive force comprises decreasing the magnitude of the propulsive force as the pitch of the foot platform moves from the first lower limit to the first upper limit. This ensures that the scooter maintains the pitch of the foot platform even when the motorized scooter is pulled along or dragged at speed.

Of course, where there is no lower limit, the step of applying a propulsive force may comprise increasing the magnitude of the propulsive force as the pitch of the foot platform reduces below the first upper limit. Thus, the lower the pitch, the greater the propulsive force.

In at least one embodiment, the at least one pitch control mode comprises a push balancing mode for use when the user desires to push the motorized scooter, wherein the motor control unit is adapted to, when operating in the push balancing mode, perform a second pitch control operation of: in response to the pitch of the foot platform falling within a second range with respect to the horizontal plane, controlling the motorized wheel to apply a braking force; and in response to the pitch of the foot falling outside of the second range, controlling the motorized wheel to not apply a braking force.

The motorized scooter is “pushed” if the motorized wheel is placed in front of the part held by the user (when transporting the motorized scooter) with respect to a user's direction of travel. Applying a braking force results in the pushing of the user changing a pitch of the foot platform by increasing the opposing force to the push, thereby angling the foot platform away from the user.

In some embodiments, the motorized scooter may be able to detect when the user is pushing or intends to push the motorized scooter, e.g. via a handle-based force sensors or accelerometer information. The control unit may enter the push balancing mode in response to the motorized scooter detecting that the user is pushing or intends to push the motorized scooter.

In some embodiments, the motor control unit may enter the push balancing mode in response to the pitch of the foot platform falling within a certain range, e.g. within the second range. Other methods of entering the push balancing mode will be apparent to the skilled person, e.g. based on a user input, in response to the pitch falling within a predefined range for at least a predefined period of time, in response to the pitch falling within a certain range and a predefined user input being provided and so on.

The second range may comprises a second lower limit and an optional second upper limit, and the second pitch control operation comprises, in response to the pitch of the foot platform being (optionally) at or above second upper limit or at or below the second lower limit, controlling the motorized wheel to not apply a braking force.

Optionally, the step of applying a braking force comprises decreasing the magnitude of the braking force as the pitch of the foot platform moves from the second lower limit to the second upper limit.

Of course, where there is no upper limit, the step of applying a braking force may comprise increasing the magnitude of the braking force as the pitch of the foot platform increases beyond the second lower limit.

In some embodiments, the first end of the platform is a fore end of the foot platform and the second end of the foot platform is an aft end of the foot platform. In other embodiments, the first end of the platform is the aft end of the foot platform and the second end of the foot platform is the fore end of the foot platform.

Optionally, the second wheel comprises a second motorized wheel; and the motor control unit, when operating in the drive mode, further controls the operation of the second motorized wheel responsive to the user input. The second motorized wheel may be made inactive (e.g. made to freewheel), or made to apply a braking force, by the motor control unit when operating in a pitch control mode. This improves the safety of the motorized scooter.

The motorized wheel may comprise an electric motor. In one example, the motorized wheel comprises a stator controlled by the motor control unit; a rotor adapted to rotate about the stator responsive to the control of the stator; and a tire connected to the rotor for contacting a ground surface. In another example, the motorized wheel comprises a geared motor or a belt-driven motor.

Preferably, when operating in a pitch control mode, the motor control unit is adapted to limit a maximum power of the motorized wheel, e.g. to no more than 50% of the maximum possible power, or no more than 25% of the maximum possible power. This improves a safety of the motorized scooter.

In particular, the motor control unit may be adapted to control the motorized wheel so that the maximum power that the motorized wheel is able to apply is less when the motor control unit operates in a pitch control mode than when the motor control unit operates in a drive mode.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIGS. 1 and 2 illustrate a motorized scooter according to an embodiment of the invention;

FIG. 3 illustrates a motorized scooter operating in a vertical balancing mode, according to an embodiment of the invention;

FIGS. 4 and 5 illustrate a motorized scooter operating in a pull balancing mode, according to an embodiment of the invention;

FIG. 6 illustrates a motorized scooter operating in a push balancing mode, according to an embodiment of the invention;

FIGS. 7 and 8 illustrate motorized scooters according to other embodiments of the invention; and

FIG. 9 illustrates a motorized wheel for use in a motorized scooter according to an embodiment of the invention.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

According to a concept of the invention, there is proposed a motorized scooter, for which an operation of the motorized wheel can be controlled based on a pitch of the foot platform. A motor control unit is operable in at least one pitch control mode, in which the operation of the motorized wheel is based upon the pitch of the foot platform, and a drive mode, in which the user controls the operation of the motorized wheel via a user input interface, in the manner of a conventional motorized scooter.

Embodiments are at least partly based on the realization that a non-zero pitch for the foot platform can assist in the transportation of the motorized scooter, e.g. by making the motorized scooter take up less width or by enabling the user to push or drag the motorized scooter. It has been recognized that the motorized wheel can be used to assist the user in angling or maintaining a non-zero pitch for the foot platform.

Illustrative embodiments may, for example, be employed in motorized scooter designed for the urban environment, in which motorized scooters may occasionally need to be transported by the user (e.g. due to space or location-based restrictions, such as on a train).

In the context of this application, a vertical axis/plane is an axis/plane that contains the local gravity direction. A horizontal axis/plane is any axis/plane perpendicular to a vertical axis/plane. A non-inclined ground surface (i.e. a flat ground surface) can be modelled/approximated as lying in a horizontal plane, so that a “horizontal ground surface” is a ground surface that can be modelled/approximated as lying in the horizontal plane.

The “pitch” of an element is defined as the magnitude of the angle that said element makes with respect to a horizontal plane. Thus, an element lying in a vertical axis has a pitch of 90°, an element lying in a horizontal plane has a pitch of 0°, and an element lying equidistant between a vertical axis and a horizontal axis has a pitch of 45°. For the sake of clarity, in the present application, the magnitude of the maximum pitch is considered to be 90°.

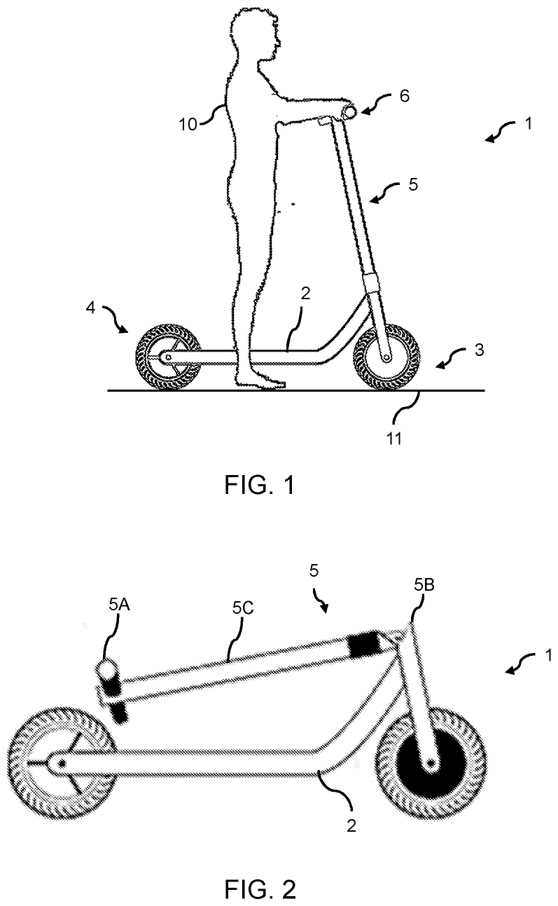

FIG. 1 illustrates a motorized scooter 1, for transporting a user 10, according to an embodiment of the invention.

The motorized scooter 1 comprises a foot platform 2, a motorized wheel 3 and a second wheel 4. The motorized wheel 3 and the second wheel 4 are disposed at opposite ends of the foot platform 1. The foot platform is adapted to support at least one foot of the user 10, so that the user 10 can stand upright on the foot platform.

The motorized scooter 1 further comprises a handle 5 for supporting a hand of the user 10. In particular, the handle 5 may be adapted or positionable to support a hand of the user 10 when the user 10 stands upright on the foot platform 2, to thereby enable a user to balance themselves on the motorized scooter. In particular, the handle 5 is located or locatable at the fore or front end of the motorized scooter 1.

The motorized scooter further comprises a user input interface 6 for receiving a first user input indicative of a desired speed of the motorized scooter. By way of example, the user input interface 5 may comprise a throttle lever (or twistgrip) and optionally a brake lever, wherein activation of the throttle lever/twistgrip indicates a desired speed or increase in speed (with activation of the optional brake lever indicating a desired reduction in speed). The user input interface 6 is preferably, and as illustrated, positioned on the handle 5 for ease of access and control by the user 10 riding the motorized scooter.

The second wheel 4 may be motorized or non-motorized (i.e. freewheeling). When the second wheel 4 is motorized, the motorized wheel 3 may be referred to as a “first motorized wheel”, and the second wheel as “second motorized wheel”, for the sake of clarity.

The motorized scooter further comprises a motor control unit (not shown) adapted to control an operation of the motorized wheel 3. In particular, the motor control unit controls a propulsive force applied by the motorized wheel 3 and optionally a braking force (i.e. a force resisting rotation or decelerating force) of the motorized wheel. The motor control unit may be integrated into the motorized wheel 3, mounted on the foot platform 2 or placed in/on the handle 5.

The motor control unit is adapted to be operable in a drive mode, in which it controls the operation (i.e. forward or rearward driving) of the motorized wheel 3 based on the first user input. In other words, the motor control unit receives the first user input from the user input interface 6 (e.g. an indication of a desire to accelerate or an indication of a desired speed) and appropriately controls the motorized wheel in response to the first user input. In this way, when the motor control unit operates in the drive control mode, the user 10 is able to control the speed of the motorized scooter using appropriate inputs via the user input interface. The “drive mode” is effectively equivalent to the conventional mode of operation for a motorized scooter.

When the second wheel 4 is motorized, the motor control unit may also control an operation of the second wheel 4 based on the user input at the user input interface.

The motorized scooter further comprises a balance sensor (not shown) adapted to identify a pitch of the foot platform with respect to a horizontal plane. The balance sensor may be positioned, for example, on the foot platform, in/on the handle or in (a non-rotating, with respect to the foot platform, part of) the motorized wheel. The relationship between the various elements of the motorized scooter will be known, allowing the pitch of the foot platform to be effectively calculated or modelled by measuring the pitch at any suitable location on the motorized scooter. Suitable examples of balance sensors will be well known to the skilled person and may comprise, for example, an accelerometer, a gyroscope or even a proximity sensor (for determining proximity from a ground surface).

The “pitch” of the foot platform is the angle that the foot platform makes, about its transverse or lateral axis (i.e. about the motorized wheel), between itself and a horizontal plane.

Conceptually, the pitch is used herein to refer to the amount that the foot platform has rotated about the motorized wheel, with respect to a position in which the foot platform lies when both the motorized wheel and the second wheel are in contact with a horizontal ground surface.

In particular, the pitch is calibrated so that a “zero pitch”, i.e. a pitch of 0°, of the foot platform occurs when the motorized wheel and the second wheel contact a ground surface 11 lying in a horizontal plane. Typically, although not essentially, this means that when the foot platform is at “zero pitch”, then it also lies in the horizontal plane.

A pitch between 0° and 90° occurs when the motorized wheel is in contact with the ground surface and the second wheel has been lifted from the ground surface, but has not been lifted such that the second wheel has been brought over the motorized wheel. A pitch of 90° occurs when the (centers of the) motorized wheel and the second wheel lie in a same vertical axis.

A negative pitch)(<0° may occur if the motorized wheel is lifted from a ground surface whilst the second wheel remains in contact with the ground surface. Detection of a sufficiently large negative pitch can be used to deactivate the motorized wheel to improve safety (i.e. prevent the motorized wheel from spinning and unintentionally injuring someone).

The motor control unit (not shown) is further adapted to be operable in at least one pitch control mode. When operating in a pitch control mode, the motor control unit (not shown) controls the operation of the motorized wheel based on at least the identified (current) pitch of the foot platform by the balance sensor.

Different types of pitch control modes are envisaged by the present invention.

For example, in at least one pitch control mode, which may be labelled a “pitch-based assistance mode”, the motor control unit may control the motorized wheel to apply a particular braking force or propulsive force when the pitch of the foot platform falls within a certain range or ranges. This can help the user to maintain or ease a control of the motorized scooter when the foot platform is at a certain pitch.

In another pitch control mode, which may be labelled a “pitch placement mode”, the motor control unit may control the motorized wheel to place the pitch of the foot platform at a certain predetermined non-zero pitch. In embodiments, the motor control unit may exit the pitch placement mode when it has performed its task of placing the pitch of the foot platform at a certain predetermined non-zero pitch.

In yet another pitch control mode, a “pitch maintaining mode”, the motor control unit may control the motorized wheel to maintain the pitch of the foot platform at a certain predetermined non-zero pitch or with a certain range of predetermined non-zero pitches. A pitch maintaining mode effectively performs iterations of a pitch placement mode.

Each at least one pitch control mode is designed for increasing an ease of transporting the motorized scooter when the user is not riding it, i.e. not standing on the foot platform. Examples of suitable pitch control modes, according to various embodiments of the invention, will be described later.

The handle 5 of the motorized scooter may be moveable with respect to the foot platform. In particular, the handle may be movable between at least a first position, in which the handle is more distant from the foot platform, and second position, in which the handle is more proximate to the foot platform.

Preferably, when the handle is in the first position, it is located at a fore end of the transportation device and is positioned so that a user is able to grip the handle to balance themselves when riding the motorized scooter. When the handle is in the second position, it is more proximate to the foot platform to provide a more compact motorized scooter.

Preferably, when the handle 5 is in the second position, it is more proximate to the second wheel 4 than when the handle is in the first position. This provides the user with a means to hold the motorized scooter when they are not riding it, and the motor control unit is operating in a pitch control mode.

In some examples, the handle 5 is adapted to rotate with respect to the foot platform, to rotate between the first and second positions. FIG. 1 illustrates the handle 5 in the first position.

FIG. 2 illustrates the motorized scooter 1, previously described, when the handle 5 has been rotated to enter into the second position. Thus, the handle is located more proximate to the foot platform 2 (and the second wheel 4) than when it was in the first position.

To enable the handle 5 to rotate with respect to the foot platform, the illustrated handle comprises a user gripping portion 5A; a rotatable mechanism 5B connected to the foot platform 2; and an elongate portion 5C connecting the user 10 gripping portion to the rotatable mechanism. In this way, the elongate portion 5C and user gripping portion 5A are able to together rotate with respect to the foot platform via the rotating mechanism.

In other embodiments, the foot platform may be moveable with respect to the handle, e.g. to rotate about the motorized wheel. The skilled person will appreciate that this is functionally equivalent to the handle being movable with respect to the foot platform.

The present invention proposes various different pitch control modes, one or more of which may be used in different embodiments of the invention or depending upon the circumstances. Examples of suitable pitch control modes are hereafter explained. The different pitch control modes increase an ease with which the user 10 can manipulate/maneuver the motorized scooter when they are not riding it, i.e. not standing on the foot platform 2.

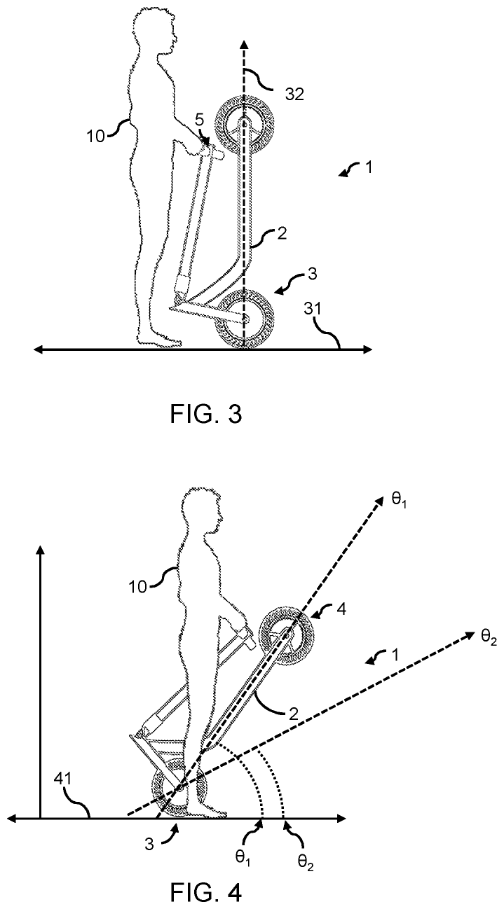

FIG. 3 elucidates a first pitch control mode according to an embodiment of the invention. The first pitch control mode may be labelled a “vertical balancing mode”, which is an example of a “pitch maintaining mode”.

In the vertical balancing mode, the motor unit of the motorized scooter controls the motorized wheel so that the pitch of the foot platform is maintained at a predefined non-zero pitch, labelled the “vertical position”, lying with a range of from 80° to 90° from a horizontal plane 31, e.g. substantially in a vertical plane 32 or substantially perpendicular to a horizontal plane.

In some embodiments, the vertical position is around 90° (e.g. ±1° or ±5°).

In other, preferred embodiments, the vertical position is defined as a pitch at which the natural balance point (center of mass) of the overall scooter is in the same vertical plane as the axle or center of the motorized wheel. That is, the “vertical position” may be a position at which the center of mass of the overall scooter is in the same vertical plane as (i.e. directly vertically above) the axle/center of the motorized wheel, which lies in the same plane as the point at which the motorized wheel touches a ground surface. The foot platform may therefore not be perfectly vertical. The skilled person would be readily capable of establishing when the center of mass of the overall scooter is in the same vertical plane as the axle/center of the motorized wheel and therefore the vertical position.

Placing the foot platform at a pitch in which the center of mass of the overall scooter is in the same vertical plane as the axle/center of the motorized wheel reduces energy consumption of the motorized scooter operating in the vertical balancing mode, as the motorized scooter will not need to be constantly driving to counteract the natural falling motion of the scooter. This is because positioning the center of mass above the axle/center of the motorized wheel allows the pitch to remain neutral. If the center of mass is displaced from the vertical plane, this will result in gravity acting on the (center of mass of the) motorized scooter producing a propulsive force about the motorised wheel, effectively attempting to adjust a pitch of the motorized scooter (which will therefore need to be counteracted by driving the motorized wheel).

The motor control unit performs the vertical balancing mode by receiving an indication, from the balance sensor, of a current pitch of the foot platform. The motor control unit then controls the motorized wheel to drive forwards and/or backwards in order to modify the pitch of the foot platform to arrive at the vertical position. The foot platform is then maintained (by appropriate driving of the motorized wheel) in the vertical position.

The motor control unit thereby identifies when the foot platform has tilted from the vertical position and controls the motorized unit to correct the tilt. The balance sensor is continually monitoring the orientation of the foot platform, which defines the operation of the balance motor control unit.

When the foot platform is in the vertical position, the rider can hold the scooter towards its highest point (e.g. by the handle) and stop the scooter from falling sideways, whilst forward and rearward falling is prevented by the motor control unit.

It will be appreciated that, once in the vertical position, attempted changes to the pitch of the foot platform will cause the motorized wheel to drive forwards or backwards. In this way, the user 10 can control a speed of the motorized scooter, to increase an ease in transporting the motorized scooter when the user 10 is not riding it. Using this technique, the scooter can be pushed forwards or backwards, with the motor control unit continually compensating for this push to thereby assist the user 10 when walking. The further the user 10 attempts to push the foot platform from the vertical, then the more the scooter compensates (by causing the motorized wheel to apply a greater propulsive force). This enables the user 10 to walk faster without applying a pushing force to the motorized scooter by simply adjusting, or attempting to adjust, a pitch of the foot platform (by trying to rotate the motorized scooter about the motorized wheel).

When the foot platform is maintained in the vertical position, the user 10 may easily turn the scooter (i.e. change a yaw of the scooter) to change its direction. Turning the scooter is easy when balancing on a single wheel, as there is only a small contact area with the ground.

The motor control unit may be adapted to, rather than simply controlling a speed and direction (forward or backwards) of the motorized wheel, also or alternatively control a braking force applied by the wheel, to enable a push/pull of the user to maintain the vertical position. That is, the motor control unit may detect a rotation of the foot platform causes by a push/pull of the user, and provide a braking force to counteract any induced rotation by the push/pull. This may be performed by detecting a rate and direction at which the pitch of the foot platform is changing, and applying a suitable braking force to counteract this change.

Of course, the vertical control mode may be adapted to maintain a pitch of the foot platform with respect to any pitch (e.g. rather than a substantially vertical pitch). Each such pitch control mode may be labeled a “pitch maintaining mode”. For example, a pitch maintaining mode may be adapted to maintain the pitch of the foot platform at substantially 45° or 60°.

FIG. 4 elucidates a second pitch control mode according to an embodiment of the invention. The second pitch control mode may be labelled a “drag balancing mode”, and is designed for use when the motorized scooter is being dragged or pulled by the user 10.

The motorized scooter is dragged when the motorized wheel is behind the part held by the user 10 (when transporting the motorized scooter) with respect to a user 10's direction of travel. That is, the motorized scooter is dragged when the center of mass of the motorized scooter is behind the force applied to the scooter by the user 10.

In the second pitch control mode, the motor control unit controls the motorized wheel with the intention of maintaining the foot platform at a predefined non-zero pitch θ₁ with respect to a horizontal plane 41.

This is achieved by the motorized wheel selectively applying a propulsive force. The propulsive force is force in the direction of travel. It will be clear that, depending upon the configuration of the motorized scooter, that the direction of travelling when the user is transporting the motorized scooter may be the same or the reverse of the direction of travel when the user is riding the motorized scooter.

Without the propulsive force, the pulling or dragging force provided by the user (pulling the transportation device), could cause the pitch of the foot platform to decrease, as the pulling force would effectively act as a torque force around the motorized wheel. In particular, friction forces acting on the motorized wheel would oppose the pulling force, causing the foot platform to rotate about the motorized wheel towards the pulling force.

When a propulsive force is applied, this induced change in pitch of the foot platform can be stopped or even reversed by applying a sufficiently high propulsive force. This understanding can be used to thereby attempt to maintain the foot platform at a predefined non-zero pitch Oi.

In particular, when operating in the second pitch control mode, the motor control unit may cause the motorized wheel to apply a propulsive force (i.e. move towards a direction of travel) when the determined pitch (by the balance sensor, not shown) of the foot platform falls within a first range. The upper limit of the first range, the “first upper limit” Oi, is a predefined non-zero pitch. The first upper limit may be alternatively referred to as a “third predefined non-zero pitch”.

Applying a sufficiently high propulsive force will cause the pitch of the foot platform to increase, as the foot platform will rotate about the forward driving motorized wheel until the first upper limit is reached. In this way, the propulsive force acts to place or move the pitch of the foot platform towards the first upper limit. In this embodiment, the second pitch control mode is an example of a “pitch maintaining mode”, as it maintains the pitch of the foot platform with the first range.

In another example, the propulsive force may be sufficient only to overcome or reduce the friction forces acting on the motorized wheel, thereby making it easy for the user to (manually) maintain an angle of the motorized scooter with respect to the horizontal plane. Thus, the propulsive force need not change the pitch of the foot platform, but may effectively contribute to a reduction in the friction forces to prevent or reduce a change in the pitch of the foot platform caused by the friction forces. In this embodiment, the push balancing mode is an example of a “pitch-based assistance mode”, as it assists the user based on a pitch.

When operating in the second pitch control mode, the motor control unit may not apply or stop applying a propulsive force to the motorized wheel when the pitch of the foot platform reaches (or exceeds) the upper limit of the first range, i.e. the predefined non-zero pitch θ₁. Thus, when the pitch of the foot platform reaches or exceeds the first upper limit θ₁, the motor control unit may stop applying power to the motorized wheel, effectively allowing it to freewheel.

This may cause the pitch of the platform to reduce (i.e. tilt towards the horizontal plane), due to the center of mass causing a rotation of the motorized scooter about the motorized wheel (due at least to the friction forces previously described). This would result in the pitch of the foot platform falling within the first range again, causing the process to repeat itself and the pitch of the foot platform being maintained substantially at or below the first upper limit θ₁.

The first range does not need to have a lower limit, i.e. it can be a one-sided range.

However, in preferred embodiments (to improve safety), the first range may comprise a lower limit, the “first lower limit” θ₂, of a lower predefined non-zero angle. During the first pitch control mode, the motor control unit may be adapted to, in response to the pitch of the foot platform being at or below the first lower limit θ₂, not apply a propulsive force to the motorized wheel.

Providing the first lower limit improves a safety of the motorized scooter, as it will prevent the motorized wheel from operating when the pitch of the foot platform is too low. A low pitch of the foot platform may be indicative that the motorized scooter has been picked up by the subject (as they will typically grasp the foot platform or further down the handle to pick the motorized scooter up). Thus, by preventing the motorized wheel from operating when the pitch of the foot platform is too low, this will prevent the motorized wheel from activating when the scooter is raised from the ground, increasing a safety of the motorized scooter.

The values of the first upper limit, and the optional first lower limit, may depend upon implementation details.

By way of example, the user 10 may be able to provide a user input defining the first upper limit to ensure that the user 10 can hold the motorized scooter at a preferred height. In other examples, the value of the first upper limit may depend upon a height of the user 10 (e.g. as indicated via a user input). In yet other examples, the value of the first upper limit may be preset (e.g. during manufacture), for example, based on average height statistics.

In one example, the first upper limit is in the range of from 50° to 80° and the first lower limit is in the range of from 30° to 50°. Preferably, the first upper limit is less than 90° or the pitch at which the foot platform lies when the center of mass of the scooter lies in the same vertical plane as the motorized wheel, i.e. the scooter is off-balance.

In a further embodiment, the magnitude of the propulsive force applied by the motorized wheel may increase between the first upper limit and the first lower limit. Thus, the magnitude of the propulsive force may be greater at the first lower limit than at the first upper limit. This helps ensure that the scooter maintains its angle when dragged or pulled along at speed (as, conventionally, a greater speed will cause a greater drop in the pitch of the foot platform due to a friction force opposing a motion of the motorized wheel).

The second pitch control mode described with reference to FIG. 4 is provided in the context of the motorized scooter being transported by the user in a configuration in which both the second wheel 4 and the part of the motorized scooter held by the user (when transporting the motorized scooter) are in front of the motorized wheel 3 with respect to a user's direction of travel.

However, the second pitch control mode may be adapted for configurations in which the motorized wheel is disposed (with respect to a user's direction of travel) between the second wheel and the part of the motorized scooter held by the user, so that the foot platform is angled away from the direction of travel. In such embodiments, a pulling force applied by the user would increase the pitch of the foot platform (rather than decreasing it).

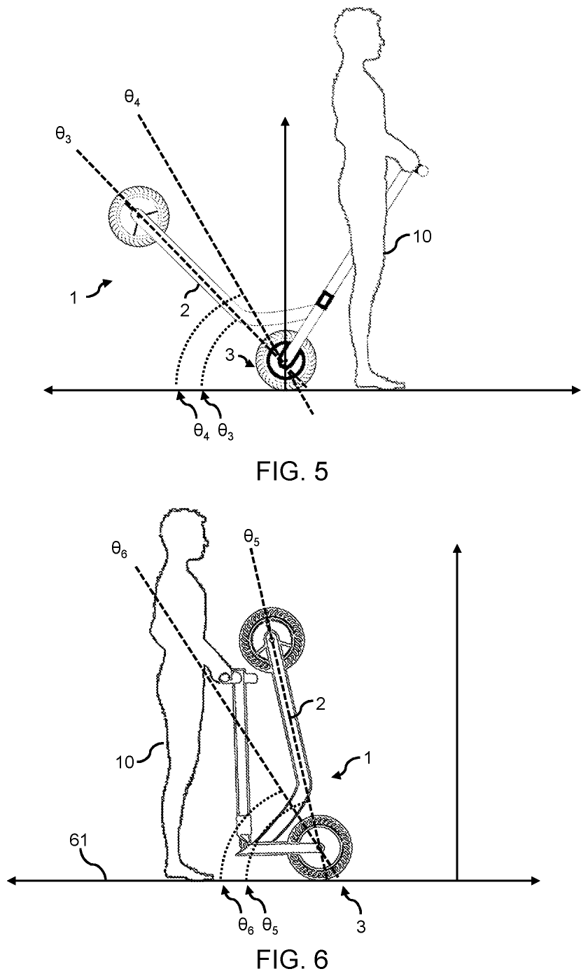

This is best illustrated by FIG. 5, which elucidates a third pitch control mode according to an embodiment of the invention. For the embodiment of FIG. 5, the motorized scooter is not in a folded configuration. The third pitch control mode is also a “drag balancing mode”, and is a modified version of the second pitch control mode.

The third pitch control mode differs from the second pitch control mode in that the motor control unit (not shown) applies a propulsive force to the motorized wheel 3 when the determined pitch of the foot platform falls within a second range having a second lower limit and an optional second upper limit (rather than an upper limit and an optional lower limit).

The second lower limit of the second range is a predefined non-zero pitch θ₃.

When operating in the third pitch control mode, the motor control unit does not apply or stops applying a propulsive force to the motorized wheel 3 when the pitch of the foot platform reaches (or falls below) the lower limit of the second range, i.e. the predefined non-zero pitch θ₃. Thus, when the pitch of the foot platform 2 reaches or falls below the second lower limit θ₃, the motor control unit controls the motorized wheel 3 to stop applying power, effectively allowing it to freewheel.

This effectively controls the pitch of the foot platform 2 in the same manner as the first pitch control mode, but takes into account the different configuration of the motorized scooter, in which the motorized wheel is located between the second wheel and the part held by the user.

In an analogous manner to the first range, to improve safety, the second range may comprise an upper limit, the “second upper limit” θ₄, of a higher predefined non-zero pitch. During the second pitch control mode, the motor control unit may be adapted to, in response to the pitch of the foot platform being at or above the second upper limit θ₄, not apply a propulsive force to the motorized wheel.

The values of the second lower limit, and the optional second upper limit, may depend upon implementation details, as previously described.

In a further embodiment, the magnitude of the propulsive force applied by the motorized wheel may increase between the second lower limit and the second upper limit. Thus, as the pitch of the foot platform moves from the second upper limit to the second lower limit, so the magnitude of the propulsive force decreases. This helps ensure that the scooter maintains its angle when dragged or pulled along at speed (as, conventionally, a greater speed will cause a greater drop in the pitch of the foot platform due to a friction force opposing a motion of the motorized wheel).

FIG. 6 elucidates a fourth pitch control mode according to an embodiment of the invention. The fourth pitch control mode may be labelled a “push balancing mode”, and is designed for use when the user 10 desires to push the motorized scooter along.

The motorized scooter 1 is pushed when the motorized wheel is in front of the part held by the user 10 (when transporting the motorized scooter 1) with respect to a user's direction of travel. That is, the motorized scooter 1 is pushed when the center of mass of the motorized scooter 1 is in front of the force applied to the scooter by the user 10, with respect to a direction of travel.

In the fourth pitch control mode, the motor control unit again controls the motorized wheel with the intention of maintaining the foot platform 2 at another predefined non-zero pitch θ₄, or within a predetermined range, with respect to a horizontal plane 61.

This is achieved by selectively controlling the motorized wheel 3 to apply a braking force. A braking force slows or stops a rotation of the wheel in the direction of travel, as would be well known to the skilled person.

Without the braking force, a push force provided by the user 10 (pushing the transportation device) could cause the pitch of the foot platform 2 to decrease or move towards the user. This is because there may not be sufficient resistance (e.g. by friction forces) to prevent the wheel from slipping or rolling away from the push force, causing the foot platform to rotate towards the user. When a braking force is applied, this induced change in pitch of the foot platform, caused by the wheel slipping away, can be stopped or even reversed (if a sufficiently high braking force is applied).

When sufficient braking force is applied, the push force provided by the user 10 contributes to a torque applied about the motorized wheel, increasing the pitch of the foot platform and effectively rotating the foot platform away from the user 10. There is therefore proposed a concept of exploiting the pushing force, provided by a user 10, to assist in the controlling or defining of the pitch of the foot platform.

When operating in the fourth pitch control mode, the motor control unit is adapted to apply a braking force to the motorized wheel in response to the pitch of the foot platform falling within a third range with respect to the horizontal plane 61. The third range has an upper limit, “third upper limit”, which is a predefined non-zero pitch θ₅.

Applying a sufficiently high braking force to the motorized wheel causes the pitch of the foot platform to rotate away from the direction of the pushing force applied by the user 10, as previously described. This would cause the pitch of the foot platform to increase (with respect to the horizontal plane 61) until the third upper limit θ₅ is reached. Thus, the braking force may co-operate with the pushing force provided by the user 10 to place the pitch of the foot platform at the third upper limit θ₅ In this embodiment, the fourth pitch control mode is an example of a “pitch maintaining mode”, as it maintains the pitch of the foot platform with the third range.

In another example, the braking force may be sufficient to provide a certain rolling resistance to the overall motorized scooter (being pushed), making it easy to maintain an angle of the motorized scooter with respect to the horizontal plane. Thus, the braking force may, in some embodiment, not be sufficient to cause a change in the pitch of the foot platform, but may make it easier for the user to maintain the pitch of the foot platform (by providing some additional resistance to slipping). In this embodiment, the fourth pitch control mode is an example of a “pitch-based assistance mode”.

When operating in the fourth pitch control mode, the motor control unit is further adapted to, in response to the pitch of the foot platform being at or above the third upper limit, not apply (or stop applying) a braking force to the motorized wheel.

This may cause the pitch of the platform to decrease, due to the center of mass causing a rotation of the motorized scooter 1. This would result in the pitch of the foot platform falling within the third range again, causing the process to repeat itself and the pitch of the foot platform being maintained substantially at or below the third upper limit θ₅.

The third range does not need to have a lower limit, i.e. it can be a one-sided range. However, in preferred embodiments (to improve safety), the third range may comprise a lower limit, the “third lower limit” 06, of a greater predefined non-zero angle. During the fourth pitch control mode, the motor control unit may be adapted to, in response to the pitch of the foot platform being at or below the third lower limit, not apply a braking force to the motorized wheel.

Providing the third lower limit improves a safety of the motorized scooter 1, as it will prevent the motorized wheel from applying a braking force when the pitch of the foot platform is too great (i.e. tilted too far).

The values of the third upper limit, and the optional third lower limit, may depend upon implementation details.

By way of example, the user 10 may be able to provide a user input defining the third upper/lower limit to ensure that the user 10 can hold the motorized scooter 1 at a preferred height. In other examples, the value of the third upper/lower limit may depend upon a height of the user 10. In yet other examples, the value of the third upper/lower limit may be preset (e.g. during manufacture), for example, based on average height statistics.

In one example, the third upper limit is in the range of from 50° to 80° and the third lower limit (if present) is in the range of from 30° to 60°, preferably 30° to 50°. For example, the third upper limit may be 75° and the third lower limit (if present) may be 45°. Preferably, the third upper limit is less than 90° or the pitch at which the foot platform lies when the center of mass of the scooter lies in the same vertical plane as the motorized wheel, i.e. the scooter is off-balance.

In a further embodiment, the magnitude of the braking force applied by the motorized wheel may decrease between the third lower limit and the third upper limit. Thus, as the pitch of the foot platform moves from the third lower limit to the third upper limit, so the magnitude of the braking force decreases. This helps ensure that the scooter maintains its angle when pushed along at speed.

In the foregoing embodiments, the pitch control modes are adapted for use when the user is not riding the motorized scooter, i.e. when the user is not standing on the food platform.

It is desirable that the motorized scooter be provided with a second handle to be held by the user when they are transporting the scooter, i.e. when they are not riding it. In particular, the second handle should allow the user to attempt to adjust a pitch of the foot platform by allowing them to lift the second wheel from the ground surface whilst keeping the motorized wheel in contact with the ground surface. The same second handle can then be used, by the user, to apply a pushing or pulling force against the transportation device in an attempt to move it.

The handle used to support a hand of the user when they are being transported by the motorized scooter may be labelled the “first handle”, as a way to distinguish the two handles from one another.

In the previously illustrated examples, a single handle 5 is positionable to act as both the “first handle” and the “second handle”. As best illustrated in FIGS. 1 and 2, this is performed be rotating the single handle with respect to the foot platform. In some embodiments, the motor control unit is configured to be operable in a pitch control mode only when the handle lies in the second position (i.e. more proximate to the foot platform). One or more sensors, e.g. a proximity sensor or the like, may be able to detect when the handle lies in the first/second position, e.g. whether or not the handle and foot platform have been folded together.

However, it is not essential that the same handle acts as both the first and second handles. Rather, the first and second handles may be separate elements.

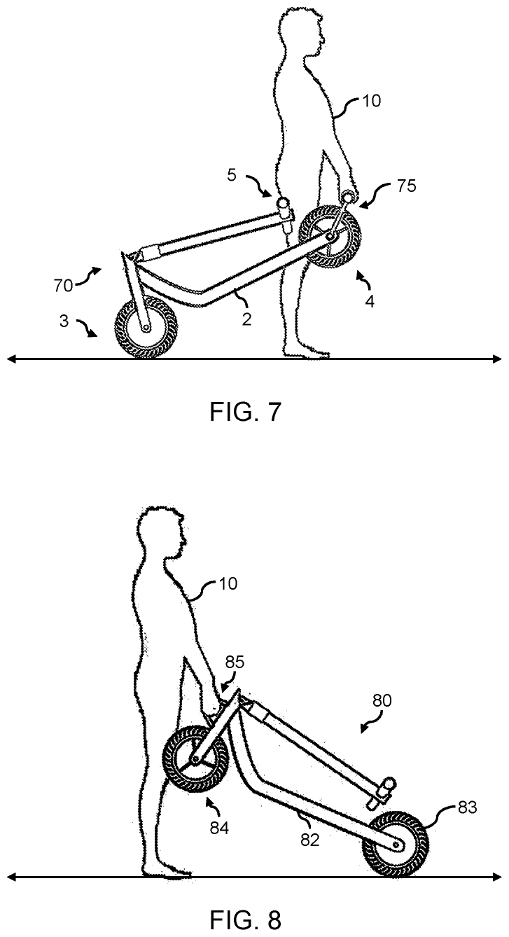

FIG. 7 illustrates an example of a motorized scooter 70 comprising two different handles 5, 75.

The motorized scooter 70 is identical to the previously described motorized scooter, except that the second wheel 4 further comprises a second handle 75 mounted thereon, to supplement the first handle 5 of the motorized scooter 70. The second handle 75 is adapted to be held by the user when they are transporting the motorized scooter, but not riding it.

By way of another example, an additional handle may be mounted on the foot platform at the end closest to the second wheel, which may be graspable by the user to lift the second wheel from the ground surface to adjust the pitch of the foot platform. Thus, embodiments may comprise an additional handle mounted on the foot platform.

In other examples, the rim of the second wheel may itself be designed to be graspable. Thus, the second wheel may act as the second handle. In some examples, the second handle may also act as a mudguard for the second wheel.

Thus, in some embodiments, such as that illustrated in FIG. 6, there is a second handle located or locatable towards the second wheel. This may be the same handle as used to support the user when they are being transported by the motorized scooter (which may be repositioned) or a different handle altogether.

When a different handle (i.e. a second, separate handle) is used for transporting the scooter, the proximity of the first handle to the foot platform may be variable, e.g. using a telescopic bar or a folding mechanism. This is illustrated in FIG. 6. This allows the scooter to be made more compact scooter when it is being transported.

In the illustrated embodiments, the motorized wheel is positioned at a fore end of the foot platform and the second wheel is positioned at an aft end of the foot platform (i.e. with respect to a desired direction of travel when the motorized scooter is transporting the user). However, in alternative embodiments, the motorized wheel is positioned at an aft end of the foot platform and the second wheel is positioned at a fore end of the foot platform. The handle or handles may be adapted accordingly.

FIG. 8 illustrates an example of a motorized scooter 80 in which the motorized wheel 83 is positioned at an aft end of the foot platform 82 and the second wheel 84 is positioned at a fore end of the foot platform 82.

The motorized scooter 80 further comprises a second handle 85 adapted to be holdable by the user when they are not riding the motorized scooter. This second handle 85 allows the user to lift the second wheel 84 from the ground surface. The motorized scooter 80 may otherwise be identical in operation to previously described motorized scooters.

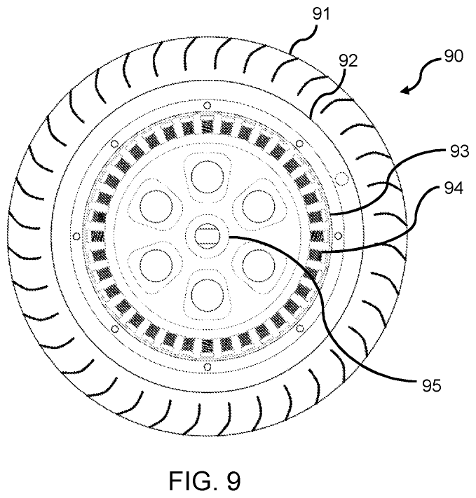

FIG. 9 illustrates an example of a motorized wheel 90 for use in a motorized scooter according to an embodiment. Other examples of suitable motorized wheels will be readily apparent to the skilled person, e.g. incorporating a geared wheel or a belt-driven wheel.

The motorized wheel 90 comprises a tire 91, a rim 92, a rotor 93, a stator 94, and an axle 95. The tire 91 is adapted for contacting a ground surface. The rim 92 is adapted to mount the tire thereon. The rotor 93 is fixedly connected to the rim 92 and is magnetically coupled to the stator 94, so as to be rotatable about the stator 94. Here, the rotor comprises a ring of permanent magnets. The stator 94 comprises a ring of electromagnetic windings, the current through which can be controlled to thereby control the torque applied to the rotor 93, and thereby the propulsive force applied by the motorized wheel. The rotor 93 is mounted on the axle 95 by at least one bearing (not shown), the bearings allowing the rotor 93 to rotate about the axle 95. The stator is fixedly coupled to the axle 95.

In this way, the motorized wheel can be controlled by controlling a current flowing through the stator 94 to control a rotation of the rotor (and thereby the rim and the tire). The motor control unit (not shown) controls the operation of the stator 94.

The motorized wheel can be controlled to propel forward by applying a torque about the rotor 93 in a desired direction of travel. This is performed by sequentially applying current through the ring of electromagnetic windings in a certain pattern, as would be well known to the skilled person.

A braking force can be applied to the wheel by either applying torque, in the manner previously described, to oppose the direction of travel or by continuously running a current through at least one coil to oppose or resist rotation of the rotor 93 about the stator 94. In this way, a braking force can be applied to the motorized wheel.

The motor control unit may be adapted to enter a particular pitch mode (or, of course, drive mode) based on a user input, e.g. provided at the user interface. Thus, the user may be able to control the mode of the motor control unit.

In some embodiments, the motor control unit may be adapted to enter a particular pitch control mode in response to the pitch of the foot platform being within a certain range, and exit the pitch control mode if it is not within that range.

By way of example, the motor control unit may enter the “vertical balancing mode” if the pitch of the foot platform falls within or enters a range of from 80° to 90°. As another example, the motor control unit may enter the “drag balancing mode” if the pitch of the foot platform falls within or enters the first range, e.g. having a (optional) lower limit of between 30° and 50° and an upper limit of from 50° to 80°. As yet another example, the motor control unit may enter the “push balancing mode” if the pitch of the foot platform falls within or enters the fourth range.

As yet another example, the motor control unit may enter the “drive mode” if the pitch falls within or enters a fourth range, e.g. having a (optional) lower limit of between −10 and 0° and an upper limit of from 0 to 50°. In particular examples, the motor control unit may enter the “drive mode” when the pitch is within the fourth range, the fourth range including at least 0°, e.g. 0°±15° and exit the drive mode when the pitch falls outside the fourth range. This prevents the motorized wheel from operating in the drive mode when both wheels are not in contact with the ground surface, thereby improving a safety of the motorized scooter.

In yet another example, the motor control unit may enter an “inactive mode” if it falls outside of a range associated with any other mode. In the inactive mode, the motor control unit may be adapted to apply no power to the motorized wheel, i.e. allowing the motorized wheel to freewheel.

In other examples, the mode of the motor control unit may remain at the most recently entered mode until a new mode is triggered, e.g. by the pitch falling or entering into a range associated with a different mode.

In particular embodiments, the motor control unit may enter the inactive mode if the pitch is less than a predefined negative angle, i.e. as this may indicate that the motorized wheel has been lifted off the floor. This predefined negative pitch may be in the range of from −5° to −20°, to account for hills which would incline the foot platform. This improves a safety of the motorized scooter.

The motor control unit may be further adapted to only enter or change the pitch control mode if the pitch of the foot platform has been within the appropriate range for a minimum period of time (e.g. at least 3 seconds or at least 5 seconds). This prevents the motor control unit from accidentally entering a different pitch control mode.

In yet other embodiments, a combination of user input and foot platform pitch may be used to define the mode of the motor control unit. For example, the user may place the foot platform within a certain range and provide a user input (e.g. press a button) indicating that the user wishes the motor control unit to operate in the associated pitch control mode.

As various embodiments may employ one or more (e.g. only one or all) of the described pitch control modes, then embodiments may employ only a selection of the respective above described ranges/parameters for entering the different pitch control modes.

In any above described embodiment, if the second wheel is motorized, the motor control unit may be adapted to prevent a propulsive force from being applied to the second wheel (e.g. allow the second wheel to freewheel) when operating in any pitch control mode. This further increases a safety of the motorized scooter.

Applying a braking force to the second wheel, when operating in a pitch control mode, yet further increases the safety of the motorized scooter by reducing the likelihood that the second wheel will catch on items in the vicinity of the second wheel. When handle is mounted upon or provided by the second wheel, this also makes the second handle easier to grip.

Preferably, when operating in a pitch control mode, the motor control unit is adapted to limit a maximum power of the motorized wheel, e.g. to no more than 50% of the maximum possible power, or no more than 25% of the maximum possible power. In particular, the limited maximum power may be insufficient to allow the user to ride the motorized scooter when in a pitch balancing mode, for improved safety. As another example, the maximum power may be limited in a pitch control mode to prevent the motor control unit attempting to abruptly drive the motorized wheel in an effort to change or maintain the pitch of the foot platform (e.g. in response to a user changing the pitch), which abrupt driving may be dangerous. Thus, limiting a maximum power of the motorized wheel in a pitch control mode improves a safety of the motorized scooter.

When operating in the drive mode, the motor control unit does not need to limit the maximum power in the same manner. By way of example, the maximum power may be limited to limit a maximum possible speed of the motorized device.

Thus, the motor control unit may be adapted to control the motorized wheel so that the maximum power that can be applied by the motorized wheel is less when the motor control unit operates in a pitch control mode than when in a drive mode. This improves a safety of the motorized scooter.

According to an aspect, there is also provided a motorized scooter for transporting a user across a ground surface, the motorized scooter comprising: a foot platform adapted to support at least one foot of the user; a motorized wheel connected to a first end of the foot platform; a second wheel connected to a second, opposite end of the foot platform; a handle for supporting a hand of the user when they are being transported by the motorized scooter; a user input interface for receiving a first user input indicative of a desired speed of the motorized scooter; and a motor control unit adapted to control an operation of the motorized wheel and operable in at least: a drive mode, during which the motor control unit controls the operation of the motorized wheel responsive to the user input; and a rolling resistance mode, during which the motor control unit controls the operation of the motorized wheel to provide a resistive braking force.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. If the term “adapted to” is used in the claims or description, it is noted the term “adapted to” is intended to be equivalent to the term “configured to”. Any reference signs in the claims should not be construed as limiting the scope.

1. A motorized scooter for transporting a user across a ground surface, the motorized scooter comprising:
a foot platform adapted to support at least one foot of the user;
a motorized wheel connected to a first end of the foot platform;
a second wheel connected to a second, opposite end of the foot platform;
a handle for supporting a hand of the user when they are being transported by the motorized scooter;
a user input interface for receiving a first user input indicative of a desired speed of the motorized scooter;
a balance sensor adapted to detect a pitch of the foot platform with respect to a horizontal plane; and
a motor control unit adapted to control an operation of the motorized wheel and operable in at least:
a drive mode, during which the motor control unit controls the operation of the motorized wheel responsive to the first user input; and
at least one pitch control mode, during which the motor control unit controls the operation of the motorized wheel based on the detected pitch of the foot platform.

2. The motorized scooter of claim 1, wherein the at least one pitch control mode comprises at least one pitch placement mode during which the motor control unit controls the operation of the motorized wheel to place the pitch of the foot platform at a predefined non-zero pitch with respect to the horizontal plane.

3. The motorized scooter of claim 2, wherein the predefined non-zero pitch of the at least one pitch placement mode is in the range of from 20° to 90° from the horizontal plane, and preferably of from 60° to 90° from the horizontal plane.

4. The motorized scooter of claim 1, wherein the at least one pitch control mode comprises a vertical balancing mode in which the motor control unit maintains the pitch of the foot platform at a first non-zero pitch with respect to the horizontal plane, wherein the first non-zero pitch is in the range of from 80° to 90° from the horizontal plane.

5. The motorized scooter of claim 1, wherein:
the handle is configured to be moveable with respect to the foot platform between at least a first position, in which the handle is more distant from the foot platform, and a second position, in which the handle is more proximate to the foot platform; and
the motor control unit is configured to be operable in a pitch control mode only when the handle lies in the second position.

6. The motorized scooter of claim 5, wherein the handle is configured to be proximate to a second end of the foot platform when in the second position.

7. The motorized scooter of any of claim 1, wherein the handle comprises:
a user gripping portion;
a rotatable mechanism connected to the foot platform; and
an elongate portion connecting the user gripping portion to the rotatable mechanism, so that the elongate portion and user gripping portion are able to together rotate with respect to the foot platform via the rotating mechanism.

8. The motorized scooter of any of claim 1, wherein the user input interface is further adapted to receive a second user input indicative of a user's desire to operate the motor control unit in a pitch control mode, wherein the motor control unit is adapted to enter a pitch control mode in response to the user input interface receiving the second user input.

9. The motorized scooter of claim 1, wherein the motor control unit is adapted to enter a pitch control mode in response to the balance sensor determining that the pitch of the motorized scooter, with respect to the horizontal plane, is greater than or equal to a second predefined non-zero pitch.

10. The motorized scooter of claim 1, wherein the at least one pitch control mode comprises a drag balancing mode for use when the user desires to drag the motorized scooter, wherein the motor control unit is adapted to, when operating in the drag balancing mode:
in response to the pitch of the foot platform falling within a first range with respect to the horizontal plane, control the motorized wheel to apply a propulsive force; and
in response to the pitch of the foot platform falling outside the first range, control the motorized wheel to not apply the propulsive force.

11. The motorized scooter of claim 10, wherein the first range comprises a first upper limit and a first lower limit, and the motor control unit is adapted to, when operating in the drag balancing mode, in response to the pitch of the foot platform being at or above the first upper limit, or at or below the first lower limit, not apply the propulsive force to the motorized wheel.

12. The motorized scooter of claim 11, wherein the step of applying a propulsive force comprises decreasing the magnitude of the propulsive force as the pitch of the foot platform moves from the first lower limit to the first upper limit.

13. The motorized scooter of claim 1, wherein the at least one pitch control mode comprises a push balancing mode for use when the user desires to push the motorized scooter, wherein the motor control unit is adapted to, when operating in the push balancing mode, perform a second pitch control operation of:
in response to the pitch of the foot platform falling within a second range with respect to the horizontal plane, controlling the motorized wheel to apply a braking force; and
in response to the pitch of the foot falling outside of the second range, controlling the motorized wheel to not apply a braking force.

14. The motorized scooter of claim 13, wherein the second range comprises a second lower limit and a second upper limit, and the second pitch control operation comprises, in response to the pitch of the foot platform being at or above second upper limit or at or below the second lower limit, controlling the motorized wheel to not apply a braking force.

15. The motorized scooter of claim 14, wherein, the step of applying a braking force comprises decreasing the magnitude of the braking force as the pitch of the foot platform moves from the second lower limit to the second upper limit.

16. The motorized scooter of scooter of claim 1, wherein the first end of the foot platform is a fore end of the foot platform and a second end of the foot platform is an aft end of the foot platform.

17. The motorized scooter of claim 1, wherein:
the second wheel comprises a second motorized wheel; and
the motor control unit, when operating in the drive mode, further controls the operation of the second motorized wheel responsive to the first user input.

18. The motorized scooter of claim 1, wherein the motorized wheel comprises an electric motor.

19. The motorized scooter of claim 18, wherein the motorized wheel comprises:
a stator controlled by the motor control unit;
a rotor adapted to rotate about the stator responsive to the control of the stator; and
a tire connected to the rotor for contacting a ground surface.

20. The motorized scooter of claim 1, wherein the motor control unit is adapted to control the motorized wheel so that the maximum power that the motorized wheel is able to apply is less when the motor control unit operates in a pitch control mode than when the motor control unit operates in a drive mode.
